(19) United States
(12) Patent Application Publication
(10) Pub. No.: US 2006/0246319 A1
(43) Pub. Date: Nov. 2, 2006

(54) Impact-resistant multilayer coating

(75) Inventors: Richard L. Bye, Morristown, NJ (US); Malak F. Malak, Tempe, AZ (US); Thomas E. Strangman, Prescott, AZ (US); Derek Raybould, Denville, NJ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/119,657

(22) Filed: May 2, 2005

(51) Int. Cl. B05D 1/08

(52) U.S. Cl. 428/698; 428/701; 428/702; 427/446; 427/596

(57) ABSTRACT

A component for a turbine engine component includes a ceramic substrate having a surface, an environmental barrier layer bonded to the substrate surface, and an impact-resistance layer bonded to the environmental barrier layer, the impact-resistance layer having a melting point higher than about 2700° F., and further having a between about 10 and about 30% porosity. The impact-resistance layer, environmental barrier layer, and interfaces at which the environmental layer is bound to the substrate surface and the impact-resistance layer are more readily shearable than the substrate. A method for protecting a turbine engine component from environmental and particle impact-related damage includes the steps of coating a substrate surface with the environmental barrier layer, and coating the environmental barrier layer with the impact-resistance layer.

This invention was made with Government support under Contract Number F33615-01-C-5230 awarded by the U.S. Air Force. The Government has certain rights in this invention.

### TECHNICAL FIELD

The present invention relates to ceramic turbine engine components that function in high temperature environments and may be exposed to velocity metallic and ceramic particles. More particularly, the present invention relates to coatings for turbine engine components to improve resistance to high-temperature combustion gas environments, high velocity particle impact, and other potentially deleterious factors.

### BACKGROUND

Turbine engines are used as the primary power source for various kinds of aircrafts. The engines are also auxiliary power sources that drive air compressors, hydraulic pumps, and industrial gas turbine (IGT) power generation. Further, the power from turbine engines is used for stationary power supplies such as backup electrical generators for hospitals and the like.

Most turbine engines generally follow the same basic power generation procedure. Compressed air is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more air into the engine and the high velocity combustion gas is passed out of the gas turbine aft end to create forward thrust. Other engines use this power to turn one or more propellers, electrical generators, or other devices. [0005] Silicon-based ceramics such as silicon nitride, silicon carbide, and their composites are used to form hot section. components in turbine engines, and particularly in advanced turbomachines. The high temperature capabilities of silicon-based ceramics enable turbomachines to operate at high temperatures with minimum cooling. However, above about 1100° C. the silicon-based ceramics can be subject to surface recession due to the presence of water vapor in the impinging combustion gas stream. For example, water vapor will react with a protective silicon oxide surface on a silicon-base ceramic substrate, converting the silicon oxide surface to a volatile silicon-hydroxide. At typical operating conditions, the surface recession rate due to water vapor attack may be in the order of a few microns per hour. Also, uncoated silicon-based ceramics may be exposed to potential high-speed impacts with small metallic and ceramic particles or debris. Flaws initiated by small particle impacts increase the potential for the silicon- based ceramics to be in need of premature replacement.

Hence, there is a need for methods and materials for coating turbine engine components such as the turbine blades and vanes. There is a particular need for environment-resistant coatings that will improve a turbine component's durability, and for efficient and cost effective methods of coating the components using such materials.

### BRIEF SUMMARY

The present invention provides a turbine engine component. The component includes a ceramic substrate having a surface, an environmental barrier layer bonded to the substrate surface, and an impact-resistance layer bonded to the environmental barrier layer, the impact-resistance layer having a melting point higher than about 2700° F., and further having between about 10 and about 30% porosity. The impact-resistance layer, environmental barrier layer, and interfaces at which the environmental layer is bound to the substrate surface and the impact-resistance layer are more readily shearable than the substrate.

A method is also provided for protecting a turbine engine component from environmental and particle impact-related damage. The method includes the steps of coating a ceramic substrate surface with an environmental barrier layer, and coating the environmental barrier layer with an impact-resistance layer as previously described.

Other independent features and advantages of the preferred article and methods will become apparent from the following detailed description, taken in conjunction with the accompanying drawings which illustrate, by way of example, the principles of the invention.

### BRIEF DESCRIPTION OF THE DRAWINGS

FIG. 1 is a cross-sectional view of a substrate being impacted by a metallic particle;

FIG. 2 is a cross-sectional view of a coating system for a substrate according to an embodiment of the present invention;

FIG. 3 is a cross-sectional view of a substrate coated with an environmental barrier layer and an impact-resistant layer according to an embodiment of the present invention, and being impacted by a metallic particle;

FIG. 4 is a perspective view of a silicon nitride blade that is exemplary of the types that are used in turbine engines; and

FIG. 5 is a plot chart displaying results from tests in which silicon nitride balls were impacted against uncoated ceramic substrates and ceramic substrates with the impacted surface coated with a coating system according to an embodiment of the present invention.

FIG. 6 is a plot chart displaying results from tests in which steel balls were impacted against uncoated ceramic substrates and ceramic substrates with the impacted surface coated with a coating system according to an embodiment of the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides a multilayer coating for a substrate such as a turbine blade or vane. The multilayer coating system inhibits environmental attack and particle impact-related damage. An outer coating layer is compressible, and interfaces between the coating layers are shearable. These factors minimize impact energy that is transferred from the particle to the load- bearing ceramic substrate, and also the shear stress on the substrate surface produced as the particle deforms and spreads about the surface

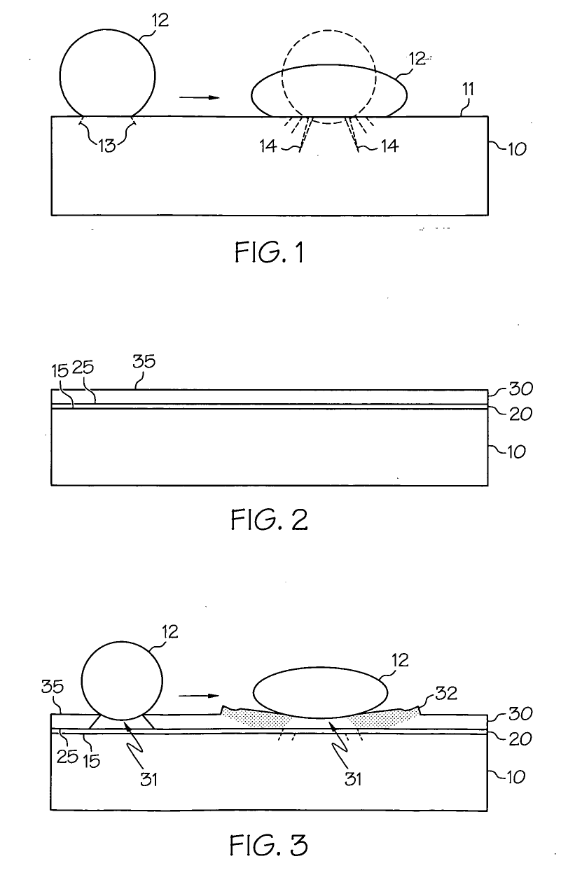

FIG. 1 is a cross-sectional view of a substrate 10 being impacted by a small metallic particle 12. Relatively large particles may be kept out of an impinging gas stream in a turbine engine by using protective devices such as screens on combustor air inlets. Consequently, only fine dust and occasional small particles are typically able to enter into the combustion gas flowpath and reach a blade, vane, or other component inside a turbine. As the particle 12 meets the substrate surface 11, the initial impact can produce tiny cracks 13. The sudden change in velocity may cause the particle 12 to expand laterally, and the expansion may create a friction force against the substrate surface 11. The friction force of the expanding particle may cause a shear stress that causes the cracks 13 to expand and further penetrate into the substrate 10 to the extent that larger cone-shaped cracks 14 are formed.

FIG. 2 is a cross-sectional view of an exemplary coating system that inhibits formation of cone-shaped cracks by limiting shear stress when particles collide with a component that includes the coating system as part of its overall structure. The substrate 10 is first coated with an environmental barrier layer 20 that effectively protects the substrate 10 from water vapor attack and oxidation damage at high temperatures during operation. An exemplary environmental barrier layer 20 includes tantalum oxide, Ta₂O₅, or a tantalum oxide-based material. The environmental barrier layer may include other materials, and may also be a plurality of layers, with one or more layers being provided to enhance coating adhesion to the substrate 10 or to inhibit oxidation of the substrate 10. A preferred environmental barrier layer includes tantalum oxide with additives that are selected according to their effect on the tantalum oxide. For example, some additives have the effect of reducing the grain growth rate of the tantalum oxide at high temperatures, while others prevent the tantalum oxide from cracking or weakening by undergoing a phase transformation during a typical operational thermal cycle. Also, some additives improve the sintering property of the tantalum oxide, and therefore cause the environmental barrier layer 20 to have increased density. Further, some additives may optimize a thermal expansion coefficient for the environmental barrier layer 20 to match that of the underlying substrate 10.

Exemplary additives for a tantalum oxide base environmental barrier layer 20 include oxides of aluminum, hafnium, silicon, lanthanum and the other rare earth metals from the lanthanum series, yttrium, niobium, titanium, and/or zirconium. A preferred environmental barrier layer 20 includes tantalum oxide alloyed with small amounts of oxides of aluminum and/or lanthanum. Additional additives such as nitrides, carbides, borides, and silicides may be included to further inhibit grain growth, modify the thermal expansion coefficient, and reinforce the tantalum oxide.

The environmental barrier layer 20 effectively protects the ceramic substrate 10 at high temperatures, particularly at a thickness that is between about 20 and about 80 μm. Several coating methods may be used to apply the environmental barrier layer 20 to the substrate 10. Exemplary coating methods include depositing processes such as electron beam-physical vapor deposition, plasma spray deposition, and slurry deposition followed by sintering. U.S. Pat. No. 6,861,164, assigned to Honeywell International, Inc. and hereby incorporated by reference, discloses a variety of tantalum oxide-based environmental barrier layers and methods for making and using them to coat a silicon-based substrate.

The environmental barrier layer top surface 25 is coated with an impact-resistant layer 30. FIG. 3 is a cross-sectional view of a substrate 10, coated with the environmental barrier layer 20 and the impact-resistant layer 30, and being impacted by a high-velocity metal particle 12. The impact-resistant layer 30 is a high melting temperature ceramic material that has a porous microstructure. Preferably, the impact-resistant layer has between about 10% and about 30% porosity. The porous structure allows the impact-resistant layer 30 to compress in a zone 31 between the particle 12 and the substrate 10, and thereby absorb some of the energy from the impacting particle 12. As metallic particles pancake or ceramic particles fracture, they shear and pulverize the impact-resistant layer 30 in a zone 32 that is adjacent to the impacting particle 12. If the particle impact has a sufficient force, the coating 30 is further compressed and sheared, and a bond between the impact-resistant layer 30 and the environmental barrier layer 20 shears at its top surface 25. Further, if the particle 12 impacts with a very strong force, shearing may occur through the environmental barrier layer 20 including the point at which it interfaces with the substrate top surface 15. Thus, the substrate 10 is protected from impact by the particle 12 because the impact-resistant layer 30, the environmental barrier layer 20, and the bonds by which they are bound to each other and to the substrate 10 are more readily shearable than the substrate 10 itself. The sheared and pulverized zone 32, coupled with the impact-induced lateral expansion on the part of the particle 12, minimizes contact shear stress on the substrate surface 15.

The impact-resistant layer 30 preferably has a melting point higher than about 2700° F., and is preferably selected to have a thermal expansion coefficient that differs from that of the environmental barrier layer 20 by at least about 20%. Shearability of the impact-resistant layer 30, particularly at the interface with the environmental barrier layer 20, is increased when the two layers have a significant difference in thermal expansion coefficients.

Exemplary materials for the impact-resistant layer 30 include varieties of stabilized zirconia. One preferred material is a stabilized tetragonal or cubic zirconia, such as yttria stabilized zirconia. Impact tests have demonstrated that stabilized zirconia and tantalum oxide have a shearable interface 25. Also, yttria stabilized zirconia has a melting point of about 4900° F. The high melting temperature provides for a stable porous microstructure within the impact-resistant layer. Other exemplary materials for the impact-resistant layer 30 include stabilized tetragonal hafnia, and stabilized cubic hafnia.

Exemplary methods for depositing the impact-resistant layer 30 include plasma spraying, slurry-sintering, and various physical deposition methods. An exemplary physical deposition method for depositing the impact-resistant layer 30 is electron beam-physical vapor deposition (EB-PVD), which produces coatings with a “ceramic rug” microstructure having columnar grains with internal nanometer-scale porosity and intercolumnar gaps that enhance the coating compliance and ability to accommodate thermal strains and thermal expansion mismatches between the impact-resistant layer 30 and the underlying substrate. An exemplary impact-resistant layer is deposited over the environmental barrier layer 20 at a thickness ranging between about 50 and about 250 μm. The impact-resistant layer 30 can be applied in a single layer, although shearing is promoted by applying the impact-resistant layer 30 as a plurality of layers with some layers having higher porosity than others.

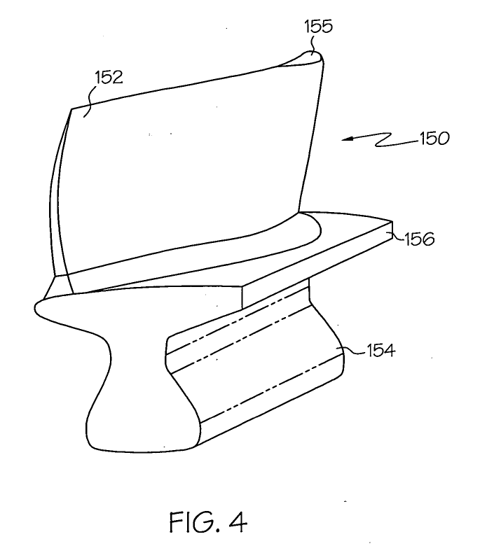

Turning now to FIG. 4, a ceramic blade 150 that is exemplary of the types that are used in turbine engines is illustrated, although turbine blades commonly have different shapes, dimensions and sizes depending on gas turbine engine models and applications. The illustrated blade 150 has an airfoil portion 152, an attachment or root portion 154, a blade tip 155, and a platform 156. The blade 150 may be formed with a non-illustrated outer shroud attached to the tip. The previously-described environmental and impact resistant coatings 20 and 30 may be applied onto the airfoil 152 and adjacent platform 156 and tip 155 surfaces.

As mentioned previously, the coating system of the present invention can be tailored to fit the blade's specific needs, which depend in part on the blade component where degradation may occur. For example, the environmental barrier coating may be applied to all surfaces exposed to moisture rich combustion gases. In contrast, the impact-resistant layer 30 may be thicker at particular locations that are most likely to be impacted by particles, such as the airfoil's leading edge.

It is also emphasized again that turbine blades are just one example of the type of turbine components that can be coated using the coating system of the present invention. Vanes, shrouds, and other turbine components can be coated in the same manner.

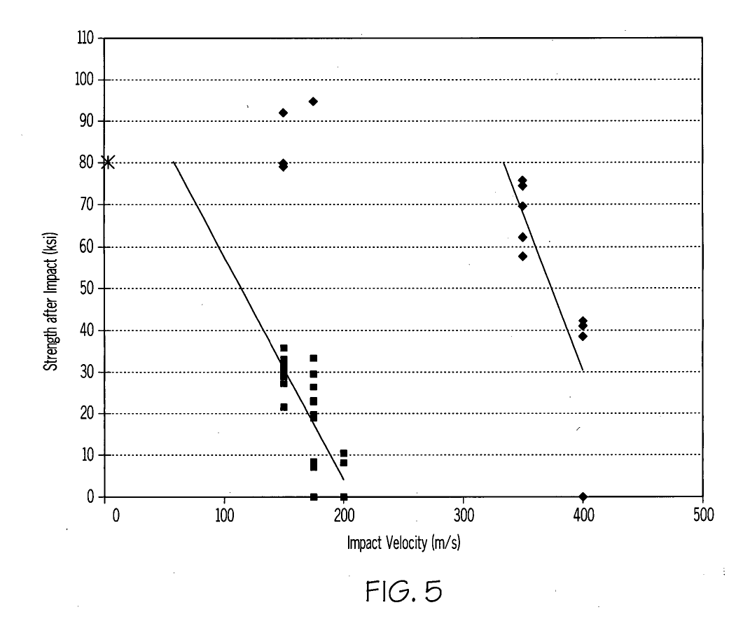

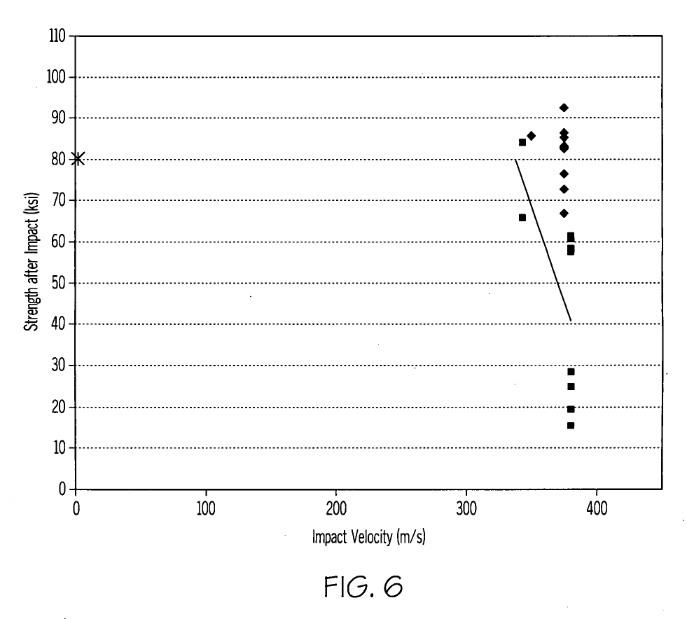

Turning now to FIG. 5 and FIG. 6, results are plotted from tests in which high-velocity 1.59 mm silicon nitride (FIG. 5) and steel balls (FIG. 6) were impacted upon AS800 silicon nitride bars coated with an environmental barrier layer of tantalum oxide alloyed with small amounts of lanthanum oxide, and with an overlaying impact-resistant coating of yttria stabilized zirconia. Tests were also conducted on specimens without the coatings for comparison purposes.

All tests were conducted on ASTM C1161 (B size) four point bend test specimens measuring 3 mm thick×4 mm wide with a minimum length of 45 mm. The bars were machined from silicon nitride blanks leaving the original sintered surface intact on one of the 4 mm wide faces. Some of the bars were then coated with an environmental barrier layer of tantalum oxide alloyed with small amounts of lanthanum oxide, and an overlaying impact-resistant coating of yttria stabilized zircoma.

Impact tests were conducted using 1.59 mm diameter balls of silicon nitride and hardened chromium steel. Target specimens were mounted firmly against a rigid backing plate and aligned to cause the projectile to impact the center of the as-sintered or coated face with a normal angle of incidence. After impact testing, bars that survived the impact were tested to determine retained strength after impact according to ASTM C1161 using a 20 mm inner span and a 40 mm outer span. Bend tests were also conducted on bars that had not been impacted to determine the baseline material strength. All strength testing was performed such that the sintered or impacted face of the specimen was placed in tension. Bars that failed upon impact at the impact site were assigned a retained strength of zero.

As shown in FIG. 5 and FIG. 6, the coated substrate had an as-received, pre-impact strength of about 80 ksi. In FIG. 5, the data points marked with a filled-in square ▪ represent the strength of a bar with a sintered surface after impact by a silicon nitride ball fired at the indicated velocity, the sintered surface being uncoated. From these data points, it is seen that without the dual layer coating of the invention, impacts by the silicon nitride balls having an impact velocity between about 150 and about 200 m/s significantly reduced the substrate strength or produce failure upon impact. The data points marked with filled-in diamonds ♦ represent the strength of a bar with a coated surface after impact by a silicon nitride ball fired at the indicated velocity. These data points reveal that no measurable strength affecting damage occurred from silicon nitride balls having an impact velocity between about 150 and about 200 m/s. In fact, the velocity threshold at which some measurable strength loss occurs is about 325 m/s, with additional strength loss occurring as the velocity was increased to 400 m/s.

In FIG. 6, the data points marked with a filled-in square ▪ represent the strength of a bar with a sintered surface after impact by a steel ball fired at the indicated velocity, the sintered surface not having been coated. From these data points, it is seen that without the dual layer coating of the invention, the velocity threshold for strength affecting damage by steel ball impacts is about 350 m/sec and the retained strength falls rapidly as the velocity is increased above that threshold. The data points marked with a filled-in diamonds ♦ represent the strength of a bar with a coated surface after impact by a steel ball fired at the indicated velocity. These data points reveal that the velocity threshold for strength affecting damage by steel ball impacts is at least 375 m/s and at that velocity, the retained strength of the coated bars is significantly greater that that of uncoated bars impacted at the same velocity.

The present invention thus provides a multilayer coating for a substrate such as a silicon-based ceramic material. The coating significantly reduces the potential for environmental or impact-related damage by minimizing impact energy and resulting stress on the underlying substrate.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

This listing of claims will replace all prior versions and listings of claims in the above-identified application:

We claim:

1. A turbine engine. component, comprising:
a ceramic substrate having a surface;
an environmental barrier layer bonded to the substrate surface; and
an impact-resistance layer bonded to the environmental barrier layer, the impact-resistance layer having a melting point higher than about 2700° F., and further having between about 10 and about 30% porosity,
wherein at least one of the impact-resistance layer, the environmental barrier layer, and an interface at which the environmental layer is bound to the substrate surface or the impact-resistance layer, is more readily shearable than the substrate.

2. The turbine engine component according to claim 1, wherein the environmental barrier layer comprises tantalum oxide.

3. The turbine engine component according to claim 2, wherein the environmental barrier layer further comprises an oxide, compound, or precursor of an element selected from the group consisting of aluminum, hafnium, silicon, a rare earth metal from the lanthanum series, yttrium, niobium, titanium, and zirconium.

4. The turbine engine component according to claim 1, wherein the impact-resistant layer comprises stabilized zirconia.

5. The turbine engine component according to claim 4, wherein the impact-resistance layer comprises a material selected from the group consisting of stabilized tetragonal zirconia, stabilized tetragonal hafnia, stabilized cubic zirconia, and stabilized cubic hafnia.

6. The turbine engine component according to claim 1, wherein the impact-resistant layer has a columnar grained microstructure with columns substantially normal to the substrate surface with submicron thickness gaps between the columns.

7. The turbine engine component according to claim 1, wherein the substrate is a silicon-based ceramic material.

8. The turbine engine component according to claim 1, wherein the environmental barrier layer and the impact-resistance layer have thermal expansion coefficients that differ by at least about 20%.

9. The turbine engine component according to claim 1, wherein the impact-resistance layer is between about 50 and about 250 microns in thickness.

10. A turbine engine component, comprising:
a silicon nitride substrate having a surface;
an environmental barrier layer coating the substrate surface, the environmental barrier layer comprising tantalum oxide; and
an impact-resistance layer coating the environmental barrier layer, the impact-resistance layer comprising stabilized zirconia.

11. A method for protecting a turbine engine component from environmental and particle impact-related damage, the method comprising the steps of:
coating a ceramic substrate surface with an environmental barrier layer; and
coating the environmental barrier layer with an impact-resistnce layer having a melting point higher than about 2700° F., and further having between about 10 and about 30% porosity,
wherein at least one of the impact-resistance layer, the environmental barrier layer, and an interface at which the environmental layer is bound to the substrate surface or the impact-resistance layer, is more readily shearable than the substrate.

12. The method according to claim 11, wherein the impact-resistance layer is deposited using an electron beam-physical vapor deposition process.

13. The method according to claim 11, wherein the impact-resistance layer is deposited using a process selected from the group consisting of a physical vapor deposition process, a plasma spraying process and a slurry-sintering process, and the environmental barrier layer is deposited using a process selected from the group consisting of a physical vapor depositing process, a plasma spraying process, and a slurry-sintering process.

14. The method according to claim 1l, wherein the environmental barrier layer comprises tantalum oxide.

15. The method according to claim 14, wherein the environmental barrier layer further comprises an oxide, compound, or precursor of an element selected from the group consisting of aluminum, hafnium, silicon, a rare earth metal from the lanthanum series, yttrium, niobium, titanium, and zirconium.

16. The method according to claim 11, wherein the impact-resistant layer comprises stabilized zirconia.

17. The method according to claim 11, wherein the impact-resistance layer comprises a material selected from the group consisting of stabilized tetragonal zirconia, stabilized tetragonal hafiia, stabilized cubic zirconia, and stabilized cubic hafnia.

18. The method according to claim 11, wherein the impact-resistant layer has a columnar grained microstructure with columns substantially normal to the substrate surface with submicron thickness gaps between the columns.

19. The method according to claim 1, wherein the environmental barrier layer and the impact-resistance layer have thermal expansion coefficients that differ by at least about 20%.

20. The method according to claim 11, wherein the impact-resistance coating is between about 50 and about 250 microns in thickness, and the environmental barrier layer is between about 20 and about 80 microns in thickness.
